(19) United States
(12) Patent Application Publication
(10) Pub. No.: US 2019/0201911 A1
(43) Pub. Date: Jul. 4, 2019

(54) SMART SNAP GRINDING JAR

(71) Applicant: FORM-TECH SCIENTIFIC INC., Verdun (CA)

(72) Inventors: Christopher W. NICKELS, Kitchener (CA); Tomislav FRISCIC, Verdun (CA)

(21) Appl. No.: 16/303,236

(22) PCT Filed: May 26, 2017
(86) PCT No.: PCT/IB2017/000745

§ 371 Date: Nov. 20, 2018

(51) Int. Cl. B02C 17/16; B02C 17/14; B02C 17/20; B02C 17/10

(52) U.S. Cl. CPC B02C 17/16; B02C 17/14; B02C 15/00; B02C 17/10; B02C 17/20

(57) ABSTRACT

A ball mill system grinds, disperses, and reacts substances. A ball mill vessel houses grinding bodies (grinding/milling media) and the materials to be ground or dispersed. The ball milling vessel includes an assembly of three component parts with active structural roles to provide a tight and repeatable seal that allows physical, structural and chemical transformations of materials in the presence of a liquid or a gas, while at the same time enabling easy and effortless opening of the jar after ball milling. The ball milling vessel includes two peripheral half-vessels made of a harder material, connected by a central thick ring made of a softer material. The connecting ring provides an active structural role in the ball milling vessel, as it holds together the peripheral halves of the vessel, while at the same time ensuring a tight seal and protecting the joint where the two half-vessels join.

### CROSS REFERENCE TO RELATED APPLICATIONS

This application claims the benefit of priority of U.S. Provisional Application No. 62/342,412, filed on May 27, 2016. This application incorporates by reference the entire contents of U.S. Provisional Application No. 62/342,412, filed on May 27, 2016.

### TECHNICAL FIELD

The invention relates to a ball mill system for grinding, dispersing, and reacting substances. More specifically, the invention relates to a ball mill vessel that houses grinding bodies (grinding/milling media) and the materials to be ground or dispersed.

### BACKGROUND

Ball mills are used to reduce solids to small particles, or to disperse solids in a liquid, or to screen for new materials, or to perform structural and chemical transformations known as mechanochemistry. There are several types of ball mills that are based on different architectures and operating principles, including roller mills, gravity mills, oscillatory (vibratory/shaker), and attrition mills. The shaker ball mills (oscillatory/vibratory mills) operate by oscillating a hollow, usually cylindrical (also spherical or egg-shaped) grinding chamber (i.e., a ball milling vessel or a jar) along an arc that is parallel to its horizontal axis. The material that is to be ground, or dispersed in a liquid, or used for materials screening, or for mechanochemical reactions is introduced into the ball mill vessel along with grinding media (milling media), such as grinding balls, milling balls, rocks, sand, or pebbles, for example. As the hollow cylindrical shell moves back and forth on the arc path, the grinding media perform complex motions that are a combination of sliding and collisions (with vessel walls, with the material being milled, or with other milling media particles) and pulverize and mix the material in the vessel. The material being milled can be one or more distinct solids, it can contain a liquid, and can even include a gas.

Ball mill systems use milling/grinding media made from different grinding materials to pulverize the solids or to disperse the solids in a liquid, or to perform mechanochemical reactions, or to screen for new materials. The material from which the grinding media are made from can include metal, rubber, ceramic, plastic, Teflon, glass balls, inorganic materials such as flint pebbles, composite materials based on inorganic compounds, such as tungsten carbide, or any combination of these. As the ball mill vessel oscillates (shakes), collisions and shear involving milling media result in grinding/milling of the material in the mill into a fine powder, and/or physicochemical transformations such as melting, eutectic formation, introduction of defects, structural rearrangements, and chemical reactions.

Some ball mill vessels are lined with an abrasion-resistant material such as manganese, steel, or rubber to facilitate the particle size reduction process, to increase the energy efficiency of the mill, and to reduce wear on the vessels.

### SUMMARY

The invention describes a novel design of a vessel (milling jar/capsule/container) for performing ball milling processes, including physical, structural and chemical transformations of materials, including but not limited to particle size reduction (comminution), alloying, amorphisation (or vitrification), and mechanochemical reactions for the synthesis or screening for inorganic materials, metal-organic materials (e.g. metal-organic frameworks and other types of compounds based on metal-ligand coordination bonds), organic solids, including pharmaceutical materials, such as cocrystals, solvates, hydrates, polymorphs, salts, and the like.

One advantage of the ball milling vessel invention is that it offers a tight seal, which allows milling in the presence of a liquid or a gas, while at the same time enabling easy and effortless opening of the jar after ball milling.

The ball milling vessel invention differs from the conventionally-used ball milling equipment, as it includes an assembly of three component parts with active structural roles, while conventional milling vessels typically consist of two parts that must fit together.

The invention includes a milling vessel for containing grinding media and a material to be ground. The milling vessel includes a connecting ring with a substantially cylindrical shape and a central long axis, a first milling chamber with an inner wall that delimits a cylindrical or conical milling chamber and having a central long axis, and a second milling chamber with an inner wall that delimits a cylindrical or conical milling chamber and has a central long axis. The first milling chamber receives a portion of the connecting ring, and the second milling chamber receives a portion of the connecting ring. The combination forms a substantially cylindrical or conical milling vessel along the central long axes of the first milling chamber, the connecting ring, and the second milling chamber.

The milling vessel can have the long axis of the connecting ring and the first milling chamber and the second milling chamber extend in a horizontal direction. Similarly, the milling vessel can also have the long axis of the connecting ring and the first milling chamber and the second milling chamber extend in a vertical direction.

In some example configurations of the invention, the milling vessel can include a grinding material inlet for feeding grinding material into the milling chamber. Likewise, in some example configurations, the milling vessel can include a grinding body inlet for introducing grinding bodies into the milling chamber. Some example configurations include a grinding material outlet for discharging ground or dispersed material from the milling chamber. In some configurations, the connecting ring includes a plastic, such as polycarbonate, polyetherether ketone, poly (methyl methacrylate), Teflon, mixtures of these plastics, and other materials that do not permanently deform during milling.

In some example configurations of the invention, the milling chamber(s) can include an alloyed metal, such as stainless steel, carbon steel, brass, and mixtures of these alloyed metals. In some configurations, the milling chamber(s) can include a base metal, such as copper, nickel, gold, silver, and mixtures of these base metals. In some example configurations of the invention, the milling chamber(s) can include plastic, such as polycarbonate, polyetherether ketone, poly (methyl methacrylate), Teflon, and mixtures of these plastics.

In some examples of the invention, the milling chamber(s) can include an inorganic compound and/or a composite material. In some examples, the milling chamber(s) include tungsten carbide and/or precious metal catalysts deposited on an interior surface of the milling chamber(s). The precious metal catalysts can include ruthenium, rhodium, palladium, and various mixtures.

In some example configurations of the invention, the first milling chamber receives a portion of the connecting ring and the second milling chamber receives a portion of the connecting ring to form a substantially right circular cylinder along the long axes of the first milling chamber, the connecting ring, and the second milling chamber. The cylindrical or conical milling chambers delimited by the inner walls of the first milling chamber and the second milling chamber can include rounded ends.

In some example configurations of the invention, the milling vessel includes a first substantially cylindrical shaped compartment having an open top, a bottom, and an annular shelf adjacent to the open top. The milling vessel further includes a second substantially cylindrical shaped compartment having an open top, a bottom, and an annular shelf adjacent to the open top. Likewise, the milling vessel includes an annular resilient connecting ring that wraps onto the annular shelf of the first substantially cylindrical shaped compartment and further wraps onto the annular shelf of the second substantially compartment joining the first and second substantially cylindrical shaped compartments to form the milling vessel. In some example configurations, the annular shelf is an interior annular shelf. When the annular resilient connecting ring is placed onto the annular shelf adjacent to the open top of the first compartment and placed onto the annular shelf adjacent to the open top of the second compartment, tension of the annular resilient connecting ring maintains a pressure on the first and second compartments to create a sealed milling vessel.

### BRIEF DESCRIPTION OF THE DRAWINGS

FIG. 1 shows a prior art ball milling vessel.

FIG. 2 shows an overview of a ball milling vessel in accordance with the claimed invention.

FIG. 3 shows one example ball milling vessel in accordance with the claimed invention.

FIG. 4 shows additional details of the connecting ring, insert, and outer shell of an exemplary ball milling vessel in accordance with the claimed invention.

### DETAILED DESCRIPTION

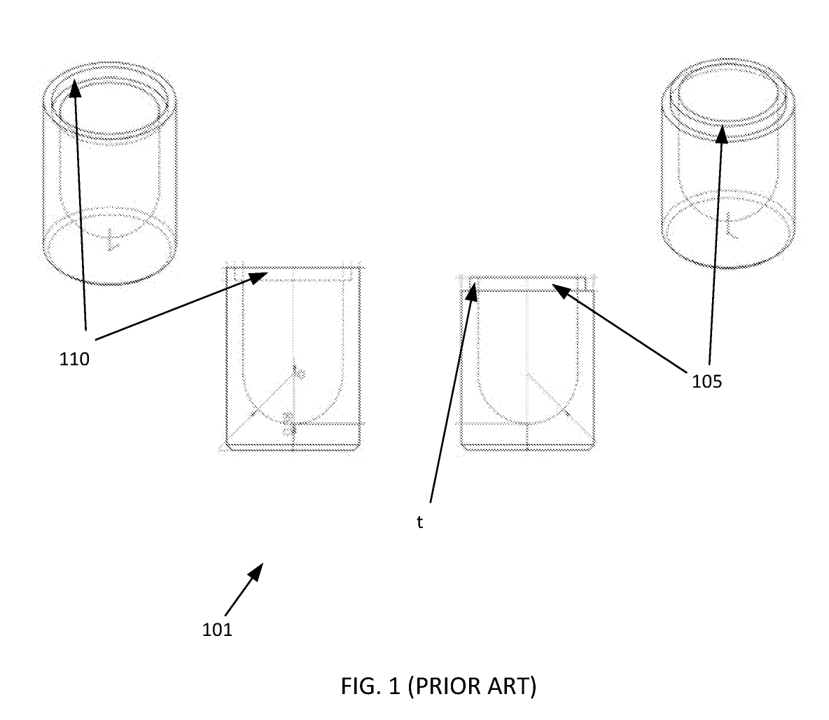

The ball milling vessel invention eliminates many of the shortcomings of prior vessels. As shown in FIG. 1, prior vessels 101 were often made entirely of stainless steel or other metals. These vessels 101 are often based upon a non-symmetrical design where one half of the vessel included a “male” fitting part (male connection 105) and a “female” fitting part (female connection 110). As grinding balls were inserted into those vessels, and the male and female halves of vessels were directly connected, sealed, and used, the grinding balls would bang around inside the vessel and against the thin male connection 105. Regardless of the size of the thin male connection 105, as the grinding balls banged against the thin male connection 105 inside the vessel 101, the grinding balls deformed the thin male connection 105 outwards against the female connection 110. This deformation causes the vessel to seal and is difficult to open after only short milling times. Also, when the vessel 101 was heated or cooled (thermal deformation), the male connection 105 and female connection 110 were susceptible to material expansion and contraction, and it was difficult to separate the two halves to open the vessel. Opening the deformed vessel often requires hammering the jar open or other mechanical interventions. As a result, the conventional equipment eventually becomes difficult to open and can also crack. Additionally, conventional vessels are often not hermetically sealed prior to deformation, much less after.

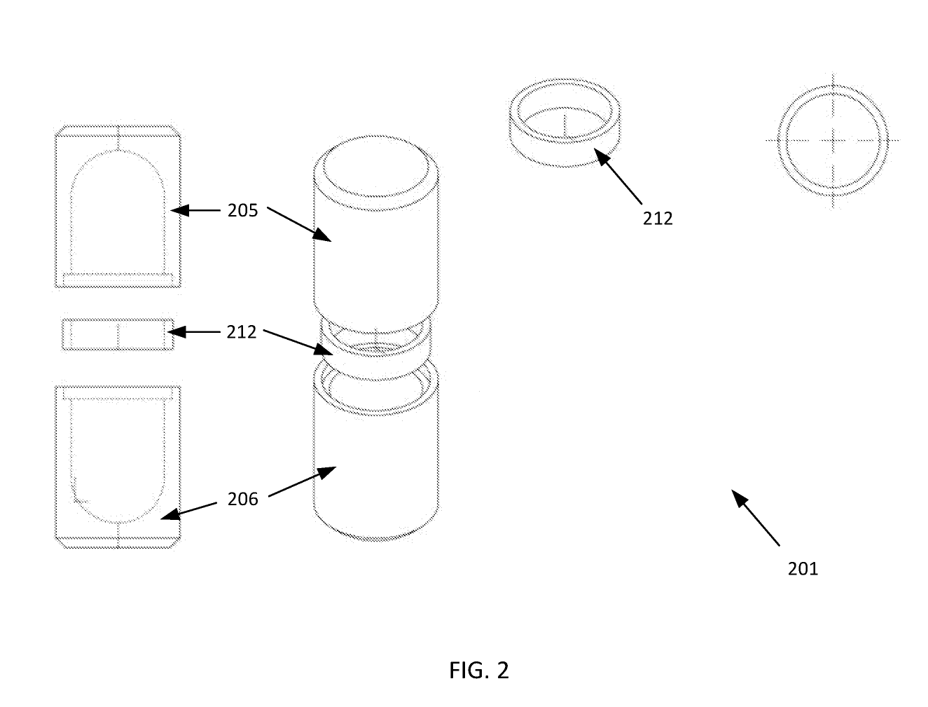

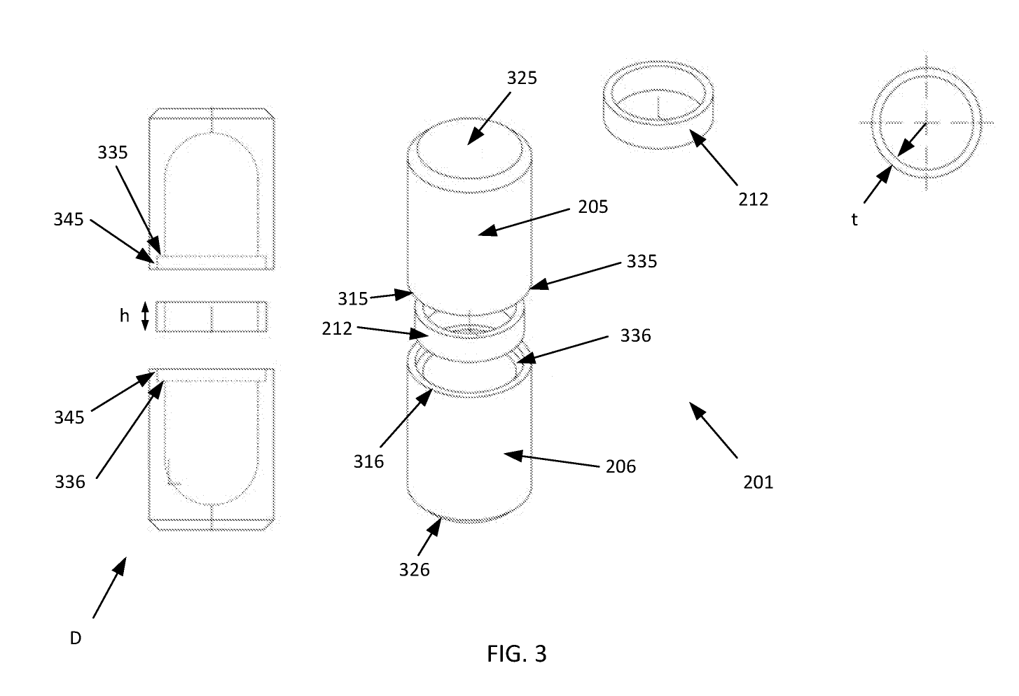

As shown in FIG. 2, one example of the ball milling vessel 201 of the claimed invention includes two identical, peripheral half-vessels 205, 206 made of a harder material, connected by a central thick ring 212 made of a softer material. This connecting ring 212 provides an active structural role in the ball milling vessel 201, as it holds together the peripheral parts (peripheral halves 205, 206) of the vessel 201, while at the same time ensuring a tight seal and protecting the joint where the two half-vessels 205, 206 join. The connecting ring 212 is not simply a sealing O-ring or a gasket, neither of which are placed on the interior, milling side of a ball milling vessel. Typically an O-ring or gasket is fitted between a male and female connection as a sealing structure and if exposed to the interior (i.e., the milling cavity of a ball milling vessel) are too thin to provide adequate compressibility or to protect the vessel from deformation. Instead, in the invention the connecting ring 212 joins the peripheral half vessels 205, 206 together and provides structural support to the vessel 201 based upon its wall thickness (t, shown, for example in FIG. 3), sealing capabilities, and height (h, also shown in FIG. 3).

As shown in FIG. 3, the milling vessel 201 includes half vessels 205, 206, and connecting ring 212. In this example embodiment, the first half vessel 205 is a substantially cylindrical shaped compartment with an open top 315, a bottom 325, and an annular shelf adjacent to the open top (shown below with regard to half vessel 206). The second half vessel 206 is also a substantially cylindrical shaped compartment with an open top 316, a bottom 326, and an annular shelf 336 adjacent to the open top 316. An annular resilient connecting ring 212 is configured to ride on the underside of the annular shelf of the first half vessel 205 and further configured to ride on the annular shelf 336 of the second half vessel 206. The first half vessel 205, second half vessel 206, and connecting ring 212 are manufactured such that the connecting ring 212 joins the first and second half vessels 205, 206 to form the milling vessel 201. The fit of the connecting ring 212 and the first and second half vessels 205, 206 is such that a tight friction fit is formed when the connecting ring 212 is placed on the annual shelves 335, 336 of the first and second half vessels 205, 206. As shown in view D of the vessel 201, the connecting ring 212 is received by the annular shelves 335, 336 when the two halves (first and second half vessels 205, 206) of the vessel 201 are brought together. The connecting ring 212 protects the lips 345, 346 of the annular shelves 335, 336 from damage and wear when the milling vessel 201 is used to grind or mill materials. As shown in the example embodiment of FIG. 3, the dimensions and tolerances of the first and second half vessels 205, 206 and the connecting ring 212 are such that the connecting ring 212 provides a positive seal of the milling vessel 201.

In one example embodiment of the invention, the ball milling vessel can be between 0.5″ and 1.5″ wide, such as approximately 1″ wide (i.e., outside diameter of the half vessels 205, 206) with a length of between approximately 2″ and 3″ long, such as approximately 2.58″ (i.e., overall length from the outer surface of bottom 325 to outer surface of bottom 326). In this example embodiment, the ring 212 can be between 0.15″ and 0.35″ wide, such as approximately 0.24″ wide (see height h in FIG. 3) with an outer diameter of between 0.75″ and 1.0″, such as 0.88″ and a thickness of between 0.04″ and 0.1″, such as 0.07″. In one example embodiment, the half vessels 205, 206 include a capsule-shaped (a.k.a. “spherocylinder,” a cylinder with hemispherical ends) interior surface that forms the milling chamber. See dashed lines in FIG. 3. When assembled, the spherocylinder can be between 2″ and 3″ long, such as approximately 2.18″ long. The hemispherical ends in one embodiment have a radius of curvature between 0.3″ and 0.5″, such as 0.38″ and the cylindrical portion of the spherocylinder has a diameter between 0.5″ and 1.0″, such as 0.75.″ In one embodiment, annular shelves 335, 336 are between 0.05″ deep and 0.2″ deep, such as approximately 0.10″ deep and surround the ring 212 to seal the milling vessel. While the dimensions discussed above are used in example embodiments of the ball milling vessel invention, many other embodiments of the ball milling vessel include variations on these shapes and dimensions and their relationships to one another.

In one example configuration of the invention, the ball milling vessel includes a stainless steel interior (spherocylindrical) surface and an anodized aluminum exterior surface. In another example configuration, the ball milling vessel includes a PTFE (Teflon) interior and an anodized aluminum exterior. In another example configuration, the ball milling vessel includes a zirconia interior and an anodized aluminum exterior, and in a further example configuration, the ball milling vessel includes a tungsten carbide interior and an anodized aluminum exterior. The exterior surfaces can also include carbon steels, alloy steels, other base metals, resins, polymers, and other materials to house the spherocylindrical vessel. The ball milling vessels can be configured in a variety of dimensions. For example, the ball milling vessels can be 5 ml, 15 ml, 30 ml or other volumes. The different interior and exterior materials can be selected based upon the milling materials, cost, weight, and other considerations.

As also shown in FIG. 3, in one example configuration of the invention, a connecting ring 212 can be designed and manufactured such that its height (h) is equal or larger than its wall thickness (t). For example, the dimension of height h of the connecting ring 212 can lie between the dimension of its wall thickness t and three times the dimension of its wall thickness t. In some embodiments of the invention, the dimension of the height h of the connecting ring 212 is between 1.5 times the dimension of the wall thickness t and 2.5 times the dimension of the wall thickness t. In other embodiments of the invention, the dimension of the height h of the connecting ring 212 is between 1.8 times the dimension of the wall thickness t and 2.2 times the dimension of the wall thickness t. In other example embodiments of the invention, the dimension of the height h of the connecting ring 212 and the dimension of the wall thickness t can be further adapted based on the milling task at hand and need have these size relationships.

When the annular resilient connecting ring 212 is placed onto the annular shelf 335 adjacent to the open top 315 of the first compartment (first half vessel 205) and placed onto the annular shelf 336 adjacent to the open top 316 of the second compartment (first half vessel 205), tension of the annular resilient connecting ring 212 maintains a pressure on the first and second compartments 205, 206 to create a sealed milling vessel 201.

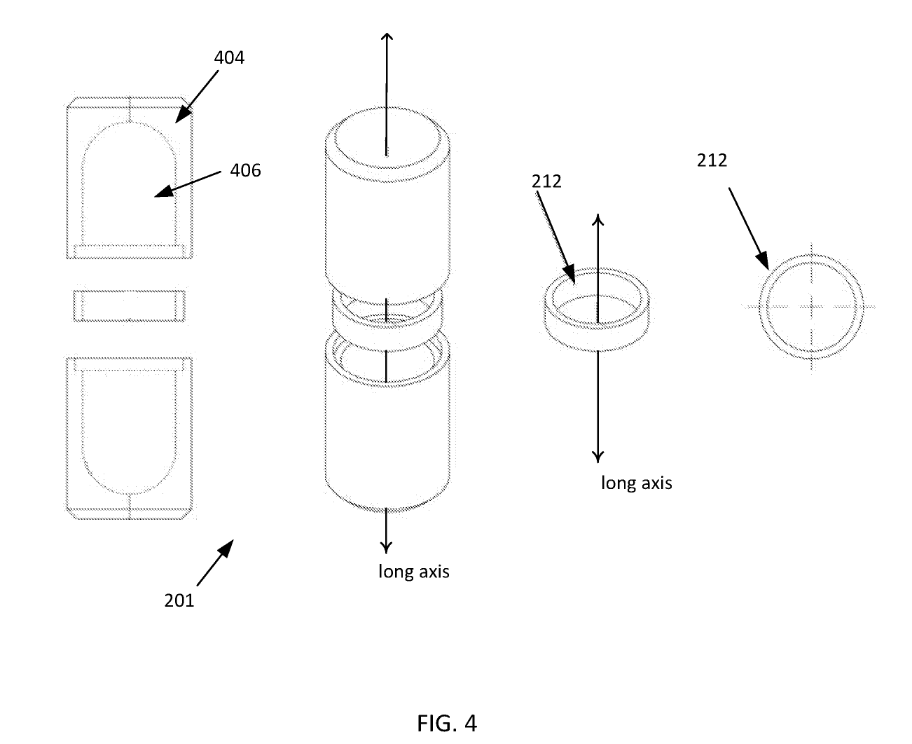

FIG. 4 illustrates an example embodiment of the new ball milling vessel 201 with the connecting ring 212 that can be made of plastics such as polycarbonate, polyetherether ketone, poly (methyl methacrylate), Teflon, and the like that have physical and chemical properties to provide structural support and sealing as well as resist chemicals used in specific reactions carried out in the vessel 201. FIG. 4 also shows the insert 406 and outer shell 404 of the new ball milling vessel 201. The outer shell 404 can be made of the same material as the rest of the vessel or it can be an insert of a different material. The insert 406 can be made of alloyed metals, base metals, plastics, ceramics, inorganic compounds, or composites based on them (e.g., tungsten carbide) and combinations of these elements. The alloyed metals can include stainless steel, carbon steel, brass, and the like. The base metals can include copper, nickel, gold, silver, etc. The plastics can include polycarbonate, polyetherether ketone, poly (methyl methacrylate), Teflon, and the like. Additionally, the insert can include a solid support with precious metal catalysts deposited on its surface, such as ruthenium, rhodium, palladium, and the like.

Additionally, the connecting portions of the ball milling vessel 201 can include lifting baffles (not shown separately) to prevent an outer layer of material to simply roll around the assembled ball milling vessel 201 as the cylindrical vessel 201 rotates, causing the media to roll, slide, and cascade.

Because the peripheral parts (peripheral halves 205, 206) in the claimed vessel 201 are not directly attached to each other, but are held together by the central ring 212, this vessel 201 is not sensitive to deformations by milling balls even after extended use. Likewise, the central ring 212 provides a positive seal regardless of whether the vessel 201 is subjected to extensive heating and/or cooling and can always be tightly closed and readily opened after use.

The claimed invention is:

1. A milling vessel for containing grinding media and a material to be ground, the milling vessel comprising:
a connecting ring with a substantially cylindrical shape and a central long axis;
a first milling chamber with an inner wall that delimits a cylindrical or conical milling chamber and having a central long axis;
a second milling chamber with an inner wall that delimits a cylindrical or conical milling chamber and having a central long axis;
wherein the first milling chamber receives a portion of the connecting ring and the second milling chamber receives a portion of the connecting ring where the combination forms a substantially cylindrical or conical milling vessel along the central long axes of the first milling chamber, the connecting ring, and the second milling chamber.

2. A milling vessel of claim 1, wherein the long axis of the connecting ring and the first milling chamber and the second milling chamber extend in a horizontal direction.

3. A milling vessel of claim 1, wherein the long axis of the connecting ring and the first milling chamber and the second milling chamber extend in a vertical direction.

4. A milling vessel of any of claims 1-3 further comprising:
a grinding material inlet for feeding grinding material into the milling chamber.

5. A milling vessel of any of claims 1-3 further comprising:
a grinding body inlet for introducing grinding bodies into the milling chamber.

6. A milling vessel of any of claims 1-5 further comprising:
a grinding material outlet for discharging ground or dispersed material from the milling chamber.

7. A milling vessel of any of claims 1-6, wherein the connecting ring includes at least one plastic including polycarbonate, polyetherether ketone, poly (methyl methacrylate), and Teflon.

8. A milling vessel of any of claims 1-7, wherein at least one of the first milling chamber and the second milling chamber comprises an alloyed metal.

9. A milling vessel of claim 8, wherein the alloyed metal includes stainless steel, carbon steel, brass, and mixtures thereof.

10. A milling vessel of any of claims 1-9, wherein at least one of the first milling chamber and the second milling chamber comprises a base metal.

11. A milling vessel of claim 10, wherein the base metal includes copper, nickel, gold, silver, and mixtures thereof.

12. A milling vessel of any of claims 1-11, wherein at least one of the first milling chamber and the second milling chamber comprises a plastic.

13. A milling vessel of claim 12, wherein the plastic includes polycarbonate, polyetherether ketone, poly (methyl methacrylate), Teflon, and mixtures thereof.

14. A milling vessel of any of claims 1-13, wherein at least one of the first milling chamber and the second milling chamber comprises at least one of an inorganic compound and a composite material.

15. A milling vessel of any of claims 1-14, wherein at least one of the first milling chamber and the second milling chamber comprises tungsten carbide.

16. A milling vessel of any of claims 1-15, wherein at least one of the first milling chamber and the second milling chamber includes precious metal catalysts deposited on its interior surface.

17. A milling vessel of claim 16, wherein the precious metal catalysts deposited on the interior surface of at least one of the first milling chamber and the second milling chamber include ruthenium, rhodium, palladium, and mixtures thereof.

18. A milling vessel of any of claims 1-17, wherein the first milling chamber receives a portion of the connecting ring and the second milling chamber receives a portion of the connecting ring to form a substantially right circular cylinder along the long axes of the first milling chamber, the connecting ring, and the second milling chamber.

19. A milling vessel of any of claims 1-18, wherein at least one of the cylindrical or conical milling chambers delimited by the inner walls of the first milling chamber and the second milling chamber includes rounded ends.

20. A milling vessel for containing grinding media and a material to be ground, the milling vessel comprising:
a first substantially cylindrical shaped compartment having an open top, a bottom, and an annular shelf adjacent to the open top;
a second substantially cylindrical shaped compartment having an open top, a bottom, and an annular shelf adjacent to the open top;
an annular resilient connecting ring configured to wrap onto the annular shelf of the first substantially cylindrical shaped compartment and further configured to wrap onto the annular shelf of the second substantially compartment joining the first and second substantially cylindrical shaped compartments to form the milling vessel.

21. A milling vessel of claim 20, wherein the annular shelf is an interior annular shelf.

22. A milling vessel of any of claims 20-21, whereby when the annular resilient connecting ring is placed onto the annular shelf adjacent to the open top of the first compartment and placed onto the annular shelf adjacent to the open top of the second compartment, tension of the annular resilient connecting ring maintains a pressure on the first and second compartments to create a sealed milling vessel.
